(19) United States
(12) Patent Application Publication
(10) Pub. No.: US 2026/0313587 A1
(43) Pub. Date: Oct. 8, 2026

(54) CARRIER WAVE TRANSMISSION FROM MULTIPLE RF RESOURCES TO AMBIENT IOT DEVICE

(71) Applicant: QUALCOMM Incorporated, San Diego, CA (US)

(72) Inventors: Chao WEI, Beijing (CN); Mingxi YIN, Beijing (CN); Kangqi LIU, San Diego, CA (US)

(21) Appl. No.: 19/478,196

(22) PCT Filed: Jun. 21, 2023
(86) PCT No.: PCT/CN2023/101674

§ 371 Date: Oct. 23, 2025

(51) Int. Cl. H04W 64/00

(52) U.S. Cl. CPC H04W 64/00

(57) ABSTRACT

Apparatus, methods, and computer program products for carrier wave transmission are provided. An example method may include receiving, from a second wireless device, a broadcast communication indicative of location information associated with a PUE, a target Rx signal power associated with an antenna of the PUE, and a power margin to the target Rx signal power. The example method may further include transmitting, based on the location information, the target Rx signal power, or the power margin, a communication to the second wireless device to indicate a presence of the first wireless device to the PUE.

### TECHNICAL FIELD

The present disclosure relates generally to communication systems, and more particularly, to wireless communication systems with carrier wave transmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first wireless device (e.g., a user equipment (UE)) are provided. The apparatus may include at least one memory and at least one processor coupled to the at least one memory. Based at least in part on stored information that is stored in the at least one memory, the at least one processor is configured to receive, from a second wireless device, a broadcast communication indicative of location information associated with a passive user equipment (PUE), a target reception (Rx) signal power associated with an antenna of the PUE, and a power margin to the target Rx signal power. Based at least in part on stored information that is stored in the at least one memory, the at least one processor is configured to transmit, based on the location information, the target Rx signal power, or the power margin, a communication to the second wireless device for radio frequency (RF) source discovery with the PUE. In some aspects, based at least in part on stored information that is stored in the at least one memory, the at least one processor is configured to receive, from a second wireless device, a group control command associated with activating a group of wireless devices including the first wireless device to transmit a carrier wave for a passive user equipment (PUE). In some aspects, based at least in part on stored information that is stored in the at least one memory, the at least one processor is configured to transmit, based on the group control command, the carrier wave to the PUE.

In another aspect of the disclosure, a method, a computer-readable medium, and an apparatus at a first wireless device (e.g., a network node such as a base station, or a UE) are provided. The apparatus may include at least one memory and at least one processor coupled to the at least one memory. Based at least in part on stored information that is stored in the at least one memory, the at least one processor is configured to transmit, for a second wireless device, a broadcast communication indicative of location information associated with a PUE, a target Rx signal power associated with an antenna of the PUE, and a power margin to the target Rx signal power. Based at least in part on stored information that is stored in the at least one memory, the at least one processor is configured to receive, based on the location information, the target Rx signal power, or the power margin, a communication from the second wireless device to indicate a presence of the first wireless device to the PUE. Based at least in part on stored information that is stored in the at least one memory, the at least one processor is configured to determine that a second wireless device is a RF source for a PUE. Based at least in part on stored information that is stored in the at least one memory, the at least one processor is configured to transmit, for a group of wireless devices including the second wireless device, a group control command associated with activating the group of wireless devices including to transmit a carrier wave to the PUE.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of an monostatic Internet of Things (IoT) deployment scenario, in accordance with various aspects of the present disclosure.

FIG. 4B is a diagram illustrating an example of an monostatic IoT deployment scenario, in accordance with various aspects of the present disclosure.

FIG. 4C is a diagram illustrating an example of a bi-static IoT deployment scenario, in accordance with various aspects of the present disclosure.

FIG. 4D is a diagram illustrating an example of a bi-static IoT deployment scenario, in accordance with various aspects of the present disclosure.

FIG. 4E is a diagram illustrating an example of a bi-static IoT deployment scenario, in accordance with various aspects of the present disclosure.

FIG. 4F is a diagram illustrating an example of a bi-static IoT deployment scenario, in accordance with various aspects of the present disclosure.

FIG. 5 is a diagram illustrating example backscatter communication, in accordance with various aspects of the present disclosure.

FIG. 6 is a diagram illustrating example RF sources transmitting energy to a passive UE, in accordance with various aspects of the present disclosure.

FIG. 7A is a diagram illustrating example RF sources transmitting carrier wave for backscattering, in accordance with various aspects of the present disclosure.

FIG. 7B is a diagram illustrating example frequencies used for backscattering, in accordance with various aspects of the present disclosure.

FIG. 8 is a diagram illustrating example communications between wireless devices, in accordance with various aspects of the present disclosure.

FIG. 9A is a diagram illustrating example ambient IoT zone associated with estimated location of PUE, in accordance with various aspects of the present disclosure.

FIG. 9B is a diagram illustrating example frequencies used for backscattering, in accordance with various aspects of the present disclosure.

FIG. 9C is a diagram illustrating example frequencies used for backscattering, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an example apparatus and/or network entity, in accordance with various aspects of the present disclosure.

FIG. 17 is a diagram illustrating an example of a hardware implementation for an example network entity, in accordance with various aspects of the present disclosure.

### DETAILED DESCRIPTION

Example aspects provided herein enable discovery of RF sources that may be suitable for transmitting a carrier wave signal to a PUE. Backscatter communications at a PUE may use a suitable input RF signal with a high signal power (e.g., −30 dBm). Therefore, a far RF source or a RF source unable to transmit at such a high signal power may be unsuitable to transmit the sinusoidal signal to the passive device. Based on the aspects provided herein, suitable RF sources may be identified more efficiently, increasing overall efficiency of the wireless communication system. In some wireless communication systems, a central node such as a network node or a UE may periodically transmit a carrier wave signal to a PUE to backscatter; and a potential RF source may measure the backscattered signal and reports the results to the central node if the potential RF source is suitable (e.g., based on satisfying some criteria for the PUE). In such an approach, the potential RF source may have capability to measure the backscattered signal which may use a different waveform than the other signals, increasing complexity at the potential RF source. Measuring the backscattered signals even if the potential RF source may be unsuitable for the carrier wave transmission may also consume power at the potential RF source. In another approach, the potential RF source may periodically transmit a carrier wave to the PUE and the reader (e.g., a network node or a UE) may measure the backscattered signal from the PUE and identify whether the RF source is close to the PUE based on the measured signal power. Such an approach may consume a lot of power at the potential RF source due to periodically transmitting the carrier wave regardless of whether the potential RF source is close to the PUE or not. Example aspects provided herein may enable reduced complexity and increased power efficiency at potential RF sources.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

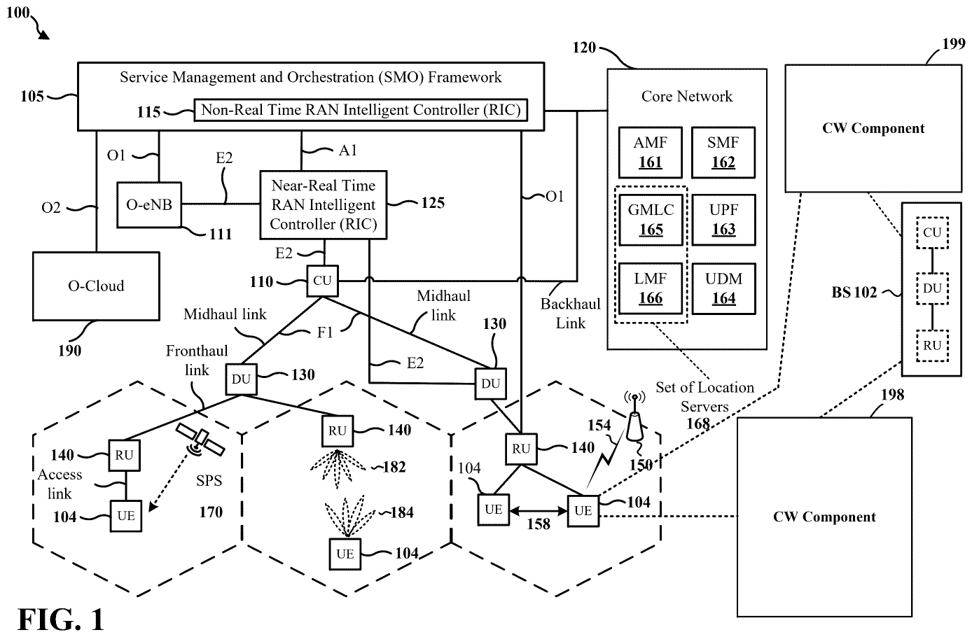

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/IL models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to YMHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, a wireless device (such as the UE 104) that supports ambient powered communication, passive communication, backscattered communication, etc. may include a CW component 198. In some aspects, the CW component 198 may be configured to receive, from a second wireless device, a broadcast communication indicative of location information associated with a PUE, a target Rx signal power associated with an antenna of the PUE, and a power margin to the target Rx signal power. In some aspects, the CW component 198 may be further configured to transmit, based on the location information, the target Rx signal power, or the power margin, a communication to the second wireless device to indicate a presence of the first wireless device to the PUE. In some aspects, the CW component 198 may be further configured to receive, from a second wireless device, a group control command associated with activating a group of wireless devices including the first wireless device to transmit a carrier wave for a PUE. In some aspects, the CW component 198 may be further configured to transmit, based on the group control command, the carrier wave to the PUE.

In certain aspects, the base station 102 may include a CW component 199. In some aspects, the CW component 199 may be configured to transmit, for a second wireless device, a broadcast communication indicative of location information associated with a PUE, a target Rx signal power associated with an antenna of the PUE, and a power margin to the target Rx signal power. In some aspects, the CW component 199 may be further configured to receive, based on the location information, the target Rx signal power, or the power margin, a communication from the second wireless device to indicate a presence of the first wireless device to the PUE. In some aspects, the CW component 199 may be further configured to determine that a second wireless device is a RF source for a PUE. In some aspects, the CW component 199 may be further configured to transmit, for a group of wireless devices including the second wireless device, a group control command associated with activating the group of wireless devices including to transmit a carrier wave to the PUE.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

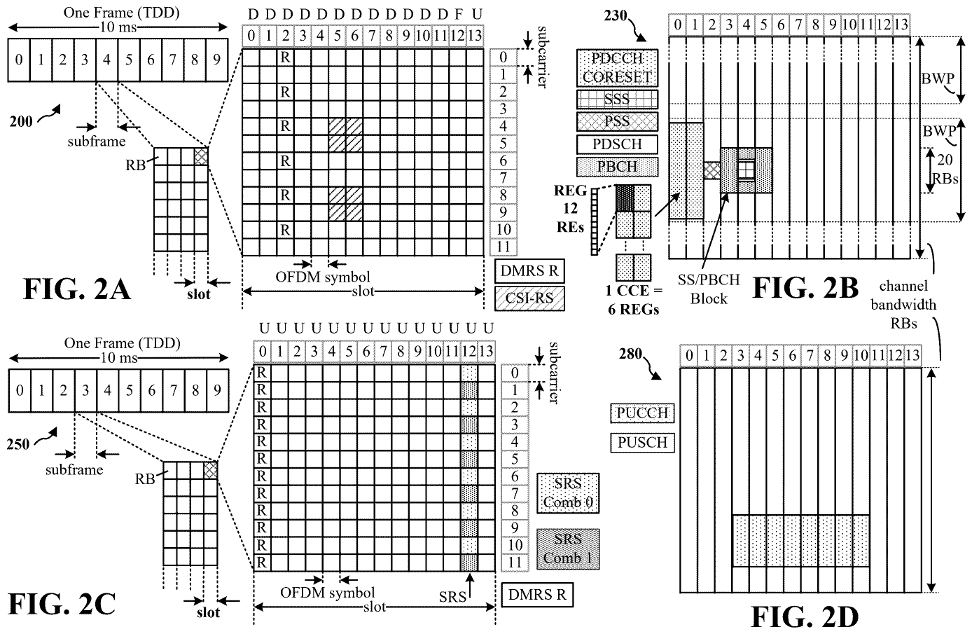

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP 14 symbols/slot), different numerologies μ0 to 4 allow or 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

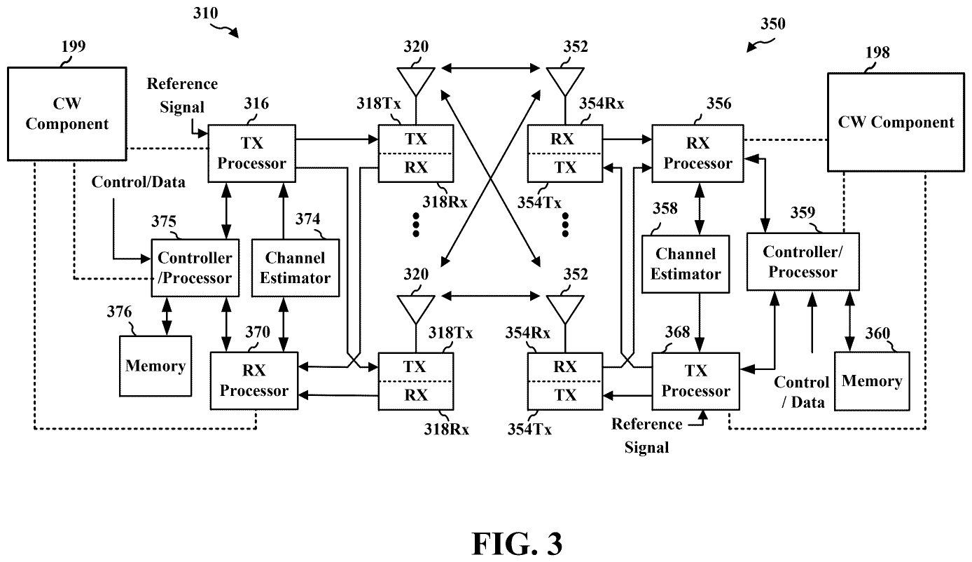

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer ofupper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with CW component 198 of FIG. 1.

At least one of the TX processor 316, the RX processor 370, and the controller/processor 375 may be configured to perform aspects in connection with CW component 199 of FIG. 1.

Wireless communication systems may include devices that use ambient power or received RF power to transmit a signal. Such devices may be referred to as supporting ambient powered transmission, supporting energy harvesting, supporting passive transmission, supporting backscatter transmission, passive UE, passive devices, or the like. In some aspects, ambient IoT (which may also be referred to as passive IoT) (A-IoT) may be useful for supporting ultra-low complexity and ultra-low power devices, providing complexity and power consumption orders of magnitude lower than other types of IoT. For example, a first type of A-IoT device (Type A) may be battery-less devices with no energy storage capability and completely dependent on the availability of an external source of energy (e.g., RF energy harvesting). A second type of A-IoT device (Type B) may be devices with small energy storage (e.g., super capacity or conventional capacity) that may not be replaced or recharged manually. A-IoT devices may be also referred to as tag or PUE. Such device may be passive and not equipped with active RF components. For example, a PUE may perform data transmission based on modulating the incident RF signals emitted by ambient transmitter (e.g., cellular mobiles or base stations). Ambient RF signals may serve as signal resource for backscattering and energy resources for harvesting.

A passive wireless device may be battery-less or battery assisted. For example, a passive wireless device may operate based on energy harvesting from an incoming radio wave with or without a battery as an additional power source. A passive wireless device may have low power consumption, such as between 1 microwatt to 1000 microwatts. Such passive wireless devices may be devices for inventory management, wireless sensors, or the like. Passive devices may use backscatter communication to communicate with another network entity, such as a base station.

Backscatter communication may enable radio frequency identification (RFID). For example, a reader may send a continuous waveform signal and interrogate commands. An RF tag (which is a passive wireless device) may harvest energy from the continuous waveform signal and may respond to the interrogation by varying its input impedance (e.g., between conjugate match and strongly mismatched), therefore modulating the backscattered signals. RFID is a rapidly growing technology impacting many industries due to its potential for inventory/asset management inside and outside warehouse, IoT, sustainable sensor networks in factories and/or agriculture, and smart home. RFID may include small transponders, which may be referred to as tags, emitting an information-bearing signal upon receiving a signal. RFID may be operated without battery at low operational expenditures (OPEX) and may use small amount of resources. RFID may have use lower amount of maintenance and may have a long life-cycle. A range of an RFID may be small.

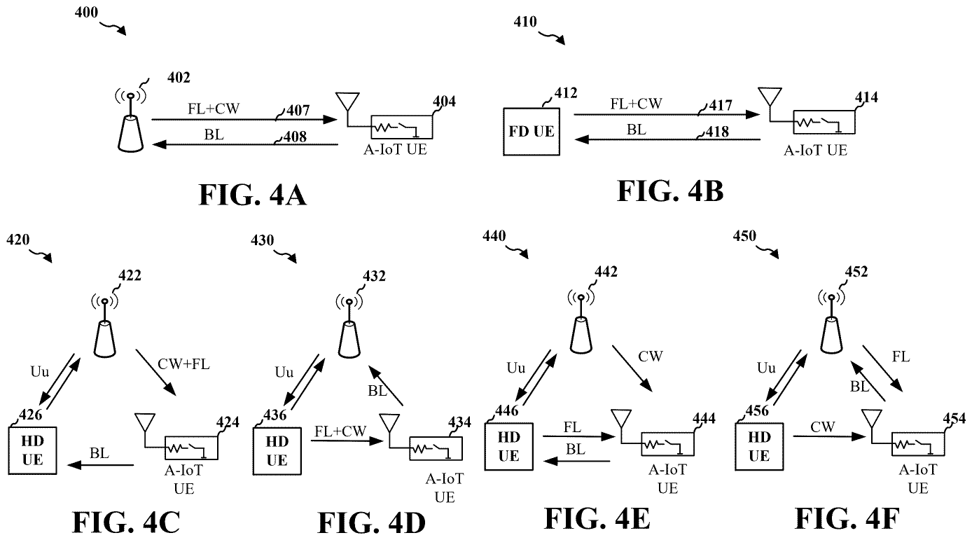

FIG. 4A is a diagram 400 illustrating an example of an monostatic Internet of Things (IoT) deployment scenario, in accordance with various aspects of the present disclosure. As illustrated in FIG. 4A, a network node 402 may transmit a front link (FL) signaling 407 which may carry control signaling with a carrier wave, which may serve as both energy source and carrier signal for backscatter communications, to an A-IoT UE 404. The A-IoT UE 404 may transmit a backscatter link (BL) communication 408 carrying data to the network node 402 based on the carrier wave.

FIG. 4B is a diagram 410 illustrating an example of an monostatic IoT deployment scenario, in accordance with various aspects of the present disclosure. As illustrated in FIG. 4A, a full-duplex UE 412 may transmit a FL signaling 417 which may carry control signaling with a carrier wave, which may serve as both energy source and carrier signal for backscatter communications, to an A-IoT UE 414. The A-IoT UE 414 may transmit a BL communication 418 carrying data to the UE 412 based on the carrier wave.

FIG. 4C is a diagram 420 illustrating an example of a bi-static IoT deployment scenario, in accordance with various aspects of the present disclosure. As illustrated in FIG. 4C, there may be a UE to network node link (e.g., a Uu link) established between a half-duplex UE 426 and a network node 422. The network node 422 may transmit a FL signaling and a CW to the A-IoT UE 424. Based on the CW, the A-IoT UE 424 may transmit a BL communication to the UE 426. The UE 426 may transmit the BL communication to the network node 422 based on the Uu link.

FIG. 4D is a diagram 430 illustrating an example of a bi-static IoT deployment scenario, in accordance with various aspects of the present disclosure. As illustrated in FIG. 4D, there may be a UE to network node link (e.g., a Uu link) established between a half-duplex UE 436 and a network node 432. The UE 436 may transmit a FL signaling and a CW to the A-IoT UE 434. For example, information in the FL signaling may be received from the network node 422 based on the Uu link. Based on the CW, the A-IoT UE 434 may transmit a BL communication to the network node 432.

FIG. 4E is a diagram 440 illustrating an example of a bi-static IoT deployment scenario, in accordance with various aspects of the present disclosure. As illustrated in FIG. 4E, there may be a UE to network node link (e.g., a Uu link) established between a half-duplex UE 446 and a network node 442. The UE 446 may transmit a FL signaling to the A-IoT UE 444. For example, information in the FL signaling may be received from the network node 442 based on the Uu link. The network node 442 may transmit a CW to the A-IoT UE 444. Based on the CW, the A-IoT UE 444 may transmit a BL communication to the UE 446. The UE 446 may transmit the BL communication to the network node 442 based on the Uu link.

FIG. 4F is a diagram 450 illustrating an example of a bi-static IoT deployment scenario, in accordance with various aspects of the present disclosure. As illustrated in FIG. 4F, there may be a UE to network node link (e.g., a Uu link) established between a half-duplex UE 456 and a network node 452. The network node 452 may transmit a FL signaling to the A-IoT UE 454. The UE 456 may transmit a CW to the A-IoT UE 454. Based on the CW, the A-IoT UE 454 may transmit a BL communication to the network node 452.

As used herein, the term “energy transfer” transfer may be used interchangeably with “energy harvesting” (EH) to refer to a procedure in which a wireless device (which may be referred to as an “energy harvesting wireless device”) uses a carrier wave transmitted by another wireless device (which may be referred to as a “power provider wireless device” to get energy). An example of an energy harvesting (EH) device may be a RF tag and an example of a power provider (PP) wireless device may be a RF interrogator (which may also be referred to as “RF reader”). Examples of an energy harvesting wireless device may include energy harvesting UEs, RFID tag with battery, RFID tag without battery, or other types of wireless devices with energy harvesting capability (e.g., based on any sources such as laser provided by network or other sources such as solar, thermal, vibration, RF from NW or other RF sources including various types of wireless communications). As used herein, the term “RF source” may refer to a wireless device, such as a UE or a base station, that may transmit a carrier wave to a PUE for transmitting a backscatter communication (which may also be referred to as “backscattering). As used herein, the term “location information” refers to actual or estimated location information, such as GPS coordinates, zone associated with a device (which may be referred to as “zone location information”), or other types of location information. In some aspects, the energy harvesting wireless device may be a UE with a modem and may be capable of performing energy harvesting. As used herein, the term “energy state” (which may also be referred to as “energy mode”, “energy information”, or “energy status”) may refer to one or more of: an energy level profile representing available energy at a device's energy storage unit or battery over time based on current measurements and prediction over time (e.g., current available energy, predicted future available energy and associated predicted time instances or durations, or the like), an energy charging profile representing energy charging rate or other energy charging related parameters related to the device's energy storage unit or battery (e.g., a current energy charging rate, predicted future energy charging rates and associated predicted time instances or durations, or the like), an energy discharging profile representing energy discharging rate (e.g., a current energy discharging rate, predicted future energy discharging rates and associated predicted time instances or durations, or the like), or other energy discharging related parameters related to the device's energy storage unit or battery. For example, an energy charging profile may include a current measured charging rate, how long the current charging rate is predicted to last, a predicted charging rate for one or more future time instances or durations, or the like. As one example, the energy charging profile may include P1, P2, P3, P4, . . . , PN (each of which represent an energy charging rate and T1 (time instance or duration predicted for charging rate P1 to last), T2 (time instance or duration predicted for charging rate P2 to last), T3 (time instance or duration predicted for charging rate P3 to last), T4 (time instance or duration predicted for charging rate P4 to last), . . . , TN (time instance or duration predicted for charging rate PN to last). In some aspects, based on an agreement with two wireless devices (such as a UE and a gNB or between two UEs), a wireless device may decide based on the profiles (e.g., and the values in each profile including P1, P2, . . . , PN, the parameters, T1, T2, . . . , TN) for each profile of the energy charging profile, the energy discharging profile, or the energy level profile. In some aspects, the term “cancel” may refer to a scenario where there is RS transmission but no DM-RS, SRS, or other RS bundling (e.g., due to power being different and potentially no coherency) or a scenario where the RS transmission and a transmission (e.g., an associated PUSCH) is not transmitted (e.g., due to having not enough power for transmission).

In backscatter communications, the information transmission may be performed by antenna modulation which does not involve active RF generation. A backscatter device may modulate the incoming RF signal by intentionally switching the load impedance to vary the amplitude or phase of its backscattered signal. For example, for amplitude shift keying (ASK) backscattering, the backscatter device switches the value of the load impedance between a very high impedance and a relatively matched load. In the high impedance case, the mismatch between antenna and load impedance may reflect all of the power back to the reader, while in the matched case, most of the power from the incoming RF signal is absorbed and little power may be reflected to the reader. The frequency of switching load impedance is associated with the data rate.

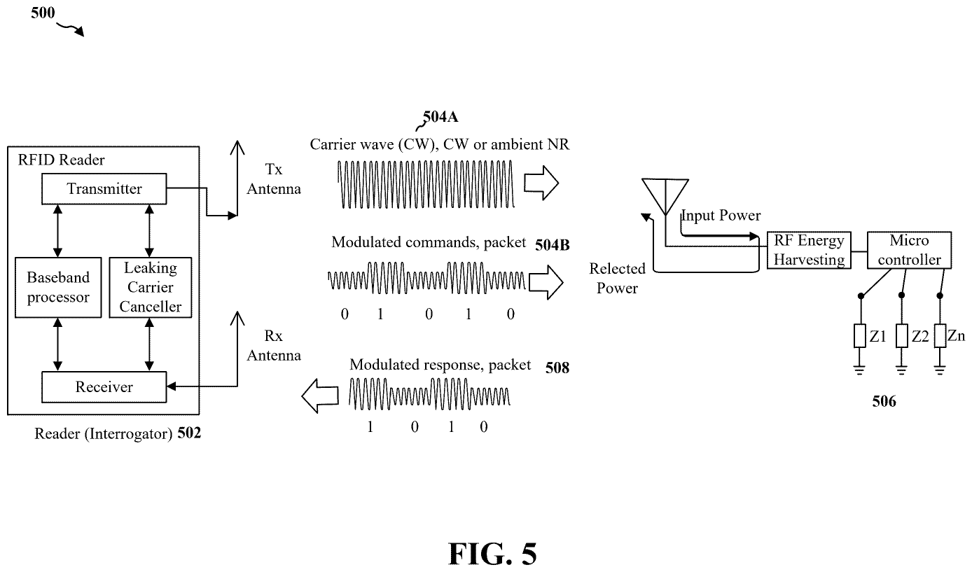

FIG. 5 is a diagram 500 illustrating example backscatter communication, in accordance with various aspects of the present disclosure. As illustrated in FIG. 5, a RF reader 502 may transmit a carrier wave (CW) 504A for powering up a backscattering device 506, which may be a RF tag. Based on the carrier wave 504A, the backscattering device 506 may be powered on. The RF reader 502 may also transmit a wave carrying modulated commands 504B to the backscattering device 506 (e.g., by modulating the CW). Based on the energy gathered from the carrier wave 504A, the backscattering device 506 may transmit (e.g., by modulating and reflecting) modulated response 508 to the RF reader.

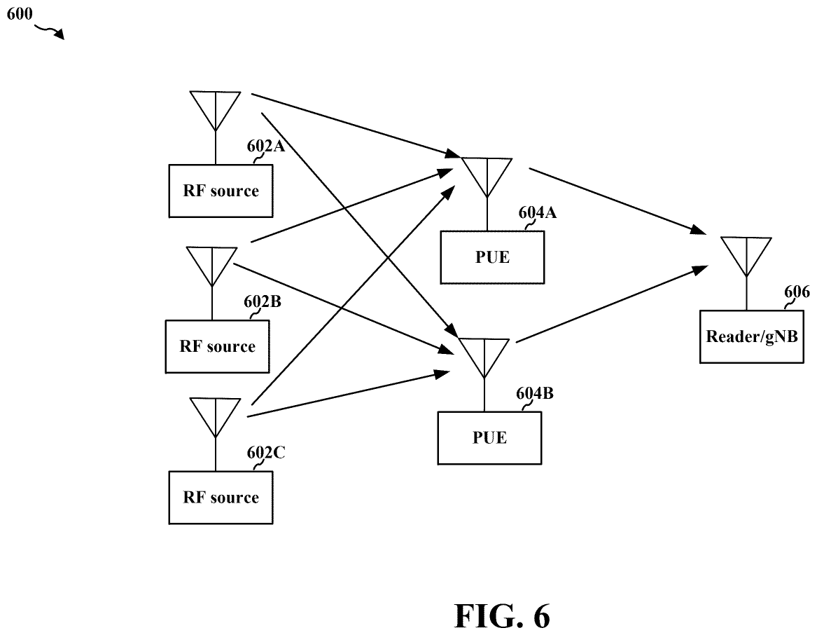

Multiple RF sources can transmit the energy signal at the same time to charge the PUE to ensure the input power to the EH circuit is above a target threshold (e.g., a threshold for energy charging rate). A central node (e.g., a network node, a UE, a reader, or the like) may broadcast the time and frequency resources for RF signal transmission. The RF sources (e.g., which may be UEs or a network node) in the range may transmit energy signals on the dedicated time and frequency resources to the target A-IoT device. The signals from the multiple RF sources may accumulated at the antenna of the A-IoT device and the total power may be increased, which may improve the EH efficiency. FIG. 6 is a diagram 600 illustrating example RF sources transmitting energy to a passive UE, in accordance with various aspects of the present disclosure. As illustrated in FIG. 6, a RF source 602A, a RF source 602B, and a RF source 602C may be all transmitting energy signals to each of PUE 604A and PUE 604B. Based on the energy signals, the PUE 604A and the PUE 604B may harvest energy and communicate with a central node 606. In some aspects, the central node 606 may broadcast the time and frequency resources for RF signal transmission. The RF sources (e.g., which may be UEs or a network node) including the RF source 602A, the RF source 602B, and the RF source 602C in the range may transmit energy signals to the PUE 604A and the PUE 604B.

In addition to energy harvesting, multiple RF sources may also be used to transmit carrier waves for backscattering. For example, multiple RF sources may transmit sinusoidal continuous wave signal simultaneously to the PUE. The multiple RF sinusoidal signals can be on the same or different frequencies, and the PUE uses the frequency shift technique for backscattering (e.g., shifting the backscattered signal to a clean channel that does not overlap with the frequencies of the RF sinusoidal signals).

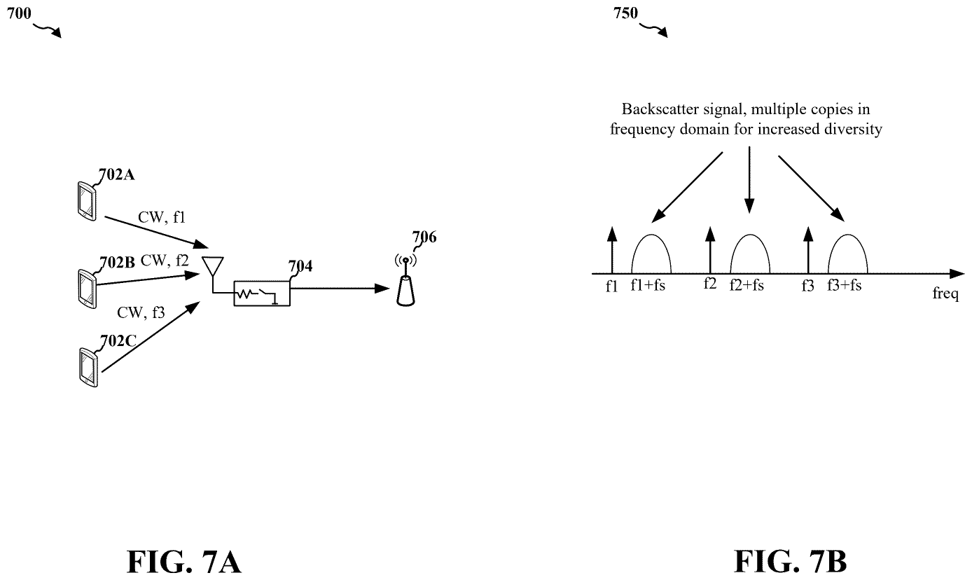

FIG. 7A is a diagram 700 illustrating example RF sources transmitting carrier wave for backscattering, in accordance with various aspects of the present disclosure. As illustrated in FIG. 7A, multiple RF sources, including UE 702A, UE 702B, and UE 702C may transmit carrier waves of different frequencies f1, f2, and f3 to the A-IoT UE 704. Based on the carrier waves the PUE 704 may transmit a backscatter communication to the network node 706.

FIG. 7B is a diagram 750 illustrating example frequencies used for backscattering, in accordance with various aspects of the present disclosure. As illustrated in FIG. 7B, three different frequencies, including f1, f2, and f3 may be used for transmitting the carrier waves. The backscattered signals in the backscatter communication may be transmitted on different signals, including f1+fs, f2+fs, and f3+fs where fs is the frequency shift for backscattering by the PUE 704.

Example aspects provided herein enable discovery of RF sources that may be suitable for transmitting a carrier wave signal to a PUE. Backscatter communications at a PUE may use a suitable input RF signal with a high signal power (e.g., −30 dBm). Therefore, a far RF source or a RF source unable to transmit at such a high signal power may be unsuitable to transmit the sinusoidal signal to the passive device. Based on the aspects provided herein, suitable RF sources may be identified more efficiently, increasing overall efficiency of the wireless communication system. In some wireless communication systems, a central node such as a network node or a UE may periodically transmit a carrier wave signal to a PUE to backscatter; and a potential RF source may measure the backscattered signal and reports the results to the central node if the potential RF source is suitable (e.g., based on satisfying some criteria for the PUE). In such an approach, the potential RF source may have capability to measure the backscattered signal which may use a different waveform than the other signals, increasing complexity at the potential RF source. Measuring the backscattered signals even if the potential RF source may be unsuitable for the carrier wave transmission may also consume power at the potential RF source. Example aspects provided herein may enable reduced complexity and increased power efficiency at potential RF sources. Example aspects provided herein may also enable scheduling and configuring multiple RF sources to transmit the carrier wave signal to the passive device for backscattering without collision. As an example, assigning a different frequency for each available RF source to avoid signal cancellation due to phase difference may avoid collision. But as the quantity of RF sources increases, the total bandwidth used may be high. For each available RF source, the central node may configure and activate the carrier wave signal transmission to the passive device, and when dedicated signaling is used, the control signaling overhead may be large. Aspects provided herein may provide layer 1 (L1) procedures and signaling for supporting carrier wave transmission from multiple RF sources to the passive device for its backscatter communications with a central node, or another wireless device.

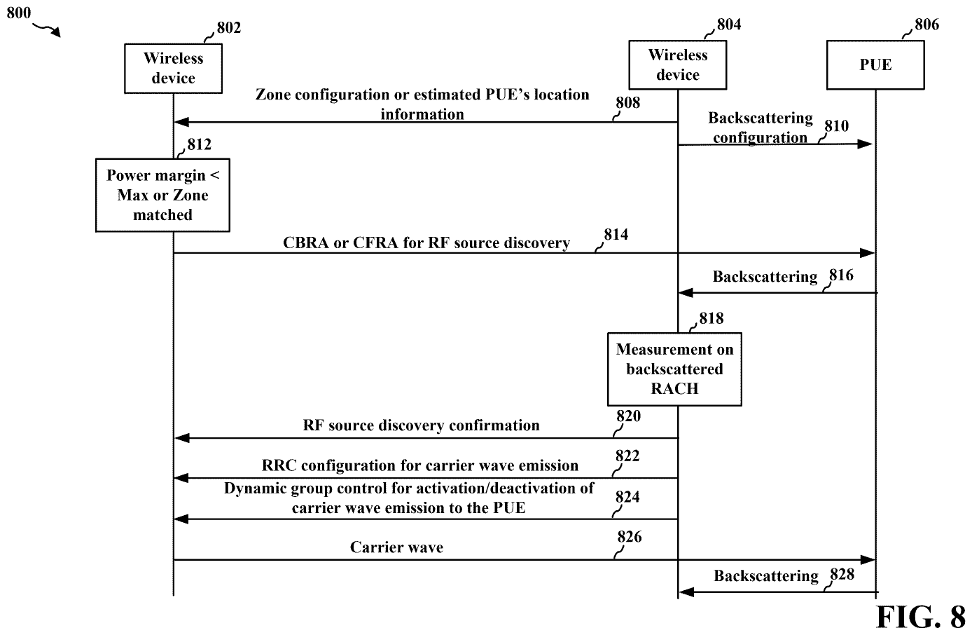

FIG. 8 is a diagram 800 illustrating example communications between wireless devices, in accordance with various aspects of the present disclosure. As illustrated in FIG. 8, a wireless device 802 may be a RF source and a wireless device 804 may be a central node. In some aspects, the wireless device 802 may be a RF source in the form of a UE or a network node. In some aspects, the wireless device 804 may be a central node in the form of a network node, or a UE. For example, a communication link between the wireless device 802 and the wireless device 804 may be a Uu link, a sidelink, or a backhaul link. The PUE 806 may be an backscatter device that communicates with other devices, such as the wireless device 804 or another wireless device based on backscatter communication performed by antenna modulation which does not involve active RF generation. The PUE 806 may be capable of modulates the incoming RF signal by switching a load impedance to vary the amplitude or phase of its backscattered signal.

As illustrated in FIG. 8, the wireless device 804 may transmit a broadcast communication 808 associated with the PUE 806, which may be in the form of zone configuration or estimated PUE's location information. The wireless device 804 may also broadcast (e.g., in the broadcast communication 808) a target Rx signal power arriving at the PUE 806's antenna, and a maximum power margin to the target Rx signal power associated with the PUE 806. As an example, the PUE 806 may be stationary and with low mobility. Therefore, the wireless device 804 may be able to estimate the location of the PUE 806 by using passive positioning techniques if the PUE 806 is connected to the wireless device 804. Alternatively, a cell may be divided into one or multiple reading zones for the PUE 806, and the wireless device 804 may broadcast the zone location information as location information of the PUE 806.

Based on the location information associated with the PUE 806 in the broadcast communication 808, at 812, the wireless device 802 may estimate a minimum pathloss to the PUE 806, such as by using a free space propagation model. The wireless device 802 may also determine a transmission power (such as a minimum transmission power) for the carrier wave signal based on the estimated pathloss and the target Rx signal power arriving at the PUE antenna. If the power margin between the minimum Tx power for the carrier wave transmission (which may be also referred to as “carrier wave emission) and the maximum Tx power of RF source is lower than the indicated maximum power margin, the wireless device 802 may determine that it is suitable for the carrier wave transmission to the target PUE 806 associated with the location information indicated by the broadcast communication 808.

In some aspects, the location information associated with the PUE 806 in the broadcast communication 808 may be zone information broadcasted by the wireless device 804 (instead of actual or estimated location information). In some of such aspects, the wireless device 802 may determine whether the wireless device 802 is suitable for the carrier wave transmission to the target PUE 806 by comparing a zone associated with the wireless device 802 and zone information associated with the PUE 806. For example, if the wireless device 802 and the PUE 806 are in a same zone or close enough zones, the wireless device 802 may be (e.g., determine that it is) suitable for the carrier wave transmission to the target PUE 806. Such zones may be ambient IoT zones that may be static and defined without signaling or dynamic centered on the estimated location of the PUE 806. Zone size associated with the zones may be configurable, such as configurable based on the target Rx signal power arriving at the PUE's antenna and a maximum power margin. In some aspects, RF sources within a zone may transmit the carrier wave to the PUE, and RF source may indicate to the central node whether it is within (e.g., or close) the zone associated with a certain PUE or not and or in which zone.

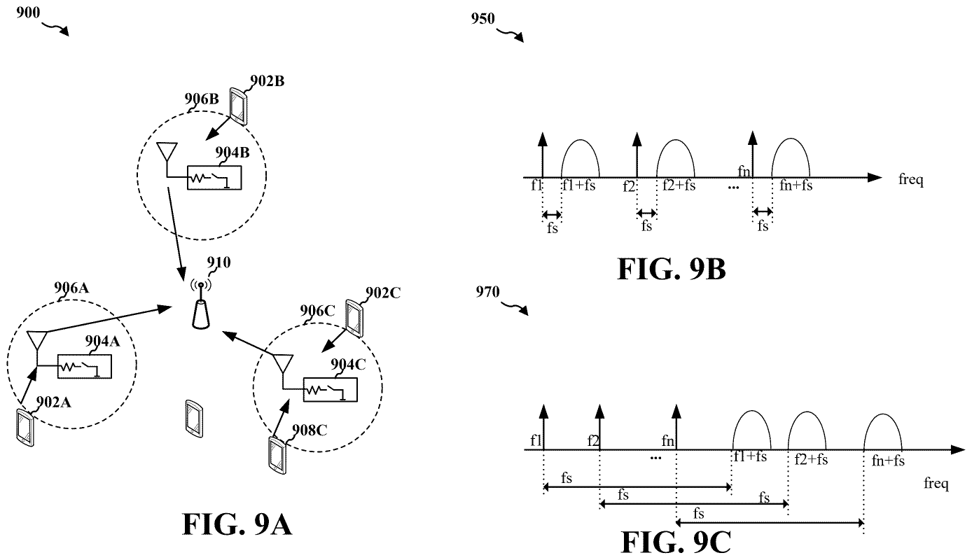

Referring to FIG. 9A, FIG. 9A is a diagram 900 illustrating example ambient IoT zone associated with estimated location of PUE, in accordance with various aspects of the present disclosure. As illustrated in FIG. 9A, the UE 902B may be within or close enough to a zone 906B associated with the PUE 904B, and may report its zone information or report that its suitable for carrier transmission for the PUE 904B to the central node 910. As illustrated in FIG. 9A, the UE 902A may be within or close enough to a zone 906A associated with the PUE 904A, and may report its zone information or report that its suitable for carrier transmission for the PUE 904A to the central node 910. As illustrated in FIG. 9A, the UE 902C and the UE 908C may be within or close enough to a zone 906C associated with the PUE 904C, and may respectively report its zone information or respectively report that its suitable for carrier transmission for the PUE 904C to the central node 910.

Referring back to FIG. 8, if a RF source such as the wireless device 802 determines that its suitable for carrier wave transmission (e.g., 826, which may enable backscattering 828) for a PUE, such as the PUE 806, the wireless device 802 may perform a RACH procedure, such as a contention based random access (CBRA) procedure or a contention free random access (CFRA) procedure 814 to indicate its presence to the PUE 806. If the procedure 814 is a CBRA procedure, the wireless device 804 may measure the backscattered preamble in the CBRA to discover the wireless device 802 as a RF source to the PUE 806. In some aspects, the preamble for RF source discovery may be single tone sinusoidal signal by reusing PRACH for NB-IoT. In some aspects, the RACH resources for RF source discovery can be zone specific or dependent on the PUE 806's location information. In some aspects, the PUE 806 may be configured with the same resources performing periodic backscattering 816 at the same time occasion or dynamically activated by the RACH preamble for backscattering. In some aspects, the wireless device 804 may provide backscattering configuration 810 to the PUE 806, which may include configuration of the resources. Upon receiving the backscattering 816, at 818, the wireless device 804 may perform measurement on the backscattered RACH to confirm whether the RACH is successful.

A RF source, such as the wireless device 802, may randomly select one occasion in the configured set of RACH resources to transmit the single tone carrier wave. Multiple RF sources may transmit at the same time occasion if one time occasion includes multiple frequency occasions corresponding to different frequencies for carrier wave emission. If the RACH is successful, the RF source, such as the wireless device 802, may be provided a configuration 822 (which may be a RRC configuration) for carrier wave emission to the PUE where the configuration may include a group random network temporary identifier (G-RNTI) G-RNTI for PDCCH monitoring, an index within the group, a list of available frequencies for the carrier wave emission (e.g., 826), or the like. In some aspects, if the RACH is successful the wireless device 804 may transmit a RF source discovery confirmation 820 to the wireless device 802. In some aspects, RF sources associated with the same PUE may be configured into a same group for enabling group control for activation and deactivation of carrier wave emission to the PUE based on a group control command 824, which may be a dynamic group control for activation and deactivation of carrier wave emission to the PUE 806.

In some aspects, if the procedure 814 is a PDCCH order based CFRA procedure, the wireless device 804 may transmit a PDCCH order to trigger a contention-free RACH for RF source discovery, i.e., RF source such as wireless device 802 transmitting a single tone PRACH (used as carrier wave for backscattering by the PUE 806). The PDCCH order may include the PUE information (e.g., zone information or other location information) used by RF source such as wireless device 802 to select the relevant PRACH resources for carrier wave emission.

The list of frequencies used for carrier wave emission may be equally spaced (e.g., f1, f1+Δ, f1+2Δ, . . . ) or separately configured (e.g., f1, f2, f3, . . . ). Referring to FIG. 9B, FIG. 9B is a diagram 950 illustrating example frequencies used for backscattering, in accordance with various aspects of the present disclosure. As illustrated in FIG. 9B, the frequencies may include large frequency spacing, used for low backscatter link rate or smaller frequency shift by backscattering.

FIG. 9C is a diagram 970 illustrating example frequencies used for backscattering, in accordance with various aspects of the present disclosure. As illustrated in FIG. 9C, the frequencies used may include small frequency spacing used for high backscatter link rate or larger frequency shift by backscattering.

In some aspects, the group control command 824 may be transmitted by the wireless device 804 to multiple RF sources, including the wireless device 802, to activate or deactivate carrier wave emission from the multiple RF sources to the same passive device (e.g., PUE 806). In some aspects, all RF sources may be activated for carrier wave emission, such as when the number of frequencies in the list is larger than the number of RF sources in the group. Each RF source may use its index in the group to select one frequency from the list for carrier wave emission. In some aspects, a subset of RF sources may be activated for carrier wave emission where the subset may be dynamically changed across slots, e.g., when the number of frequencies in the list is smaller than the number of RF sources in the group. For example, the RF sources in a group may be further divided into K subgroups and one RF source may be randomly selected from each subgroup for carrier wave emission. Therefore, a total of K RF sources may be transmitted in every slot, where K may be same as the quantity of frequencies in the list or separately configured. In some aspects, the random selection of the RF source can be based on a cell-specific pseudo-random sequence c(n), e.g.,

$$f ( n ) = ( {\sum }_{i = 0}^{7} c ( 8 n + i ) \cdot {2}^{i} ) mod N ,$$

where n is the slot number and N is quantity of RF sources in the subgroup. The pseudo-random sequence generator c(n) may be initialized with the cell ID or the subgroup index.

In some aspects, a higher layer may configure whether a subset of RF sources may be activated for carrier wave emission or all RF sources may be activated for carrier wave emission. In some aspects, whether a subset of RF sources may be activated for carrier wave emission or all RF sources may be activated for carrier wave emission may be dynamically indicated in the group control command 824.

In some aspects, group control command 824 may also include dynamic power control command. For example, in some aspects, the dynamic control command may include a power up or down command to update the Tx power for the carrier wave emission. The power control command may be common for all the RF sources or independently for each RF source. In some aspects, each RF source may maintain two separate power control loops, one for communications with the wireless device 804 and the other for the carrier wave emission to the PUE 806. In some aspects, the group control command 824 may also enable or disable carrier wave emission from each individual RF source. For example, the enabling or disabling may based on the frequency list. If one frequency in the list is disabled, then all the RF sources associated with the frequency may stop transmitting the carrier wave to the PUE 806.

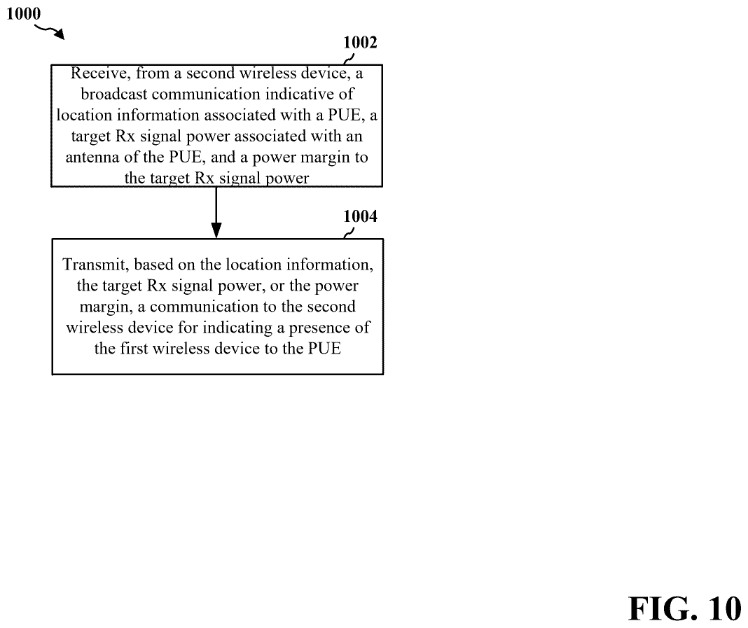

FIG. 10 is a flowchart 1000 of a method of wireless communication. The method may be performed by a first wireless device, such as a UE (e.g., the UE 104, the wireless device 802; the apparatus 1604). The method may be used to facilitate identifying RF sources for PUEs.

At 1002, the wireless device may receive, from a second wireless device, a broadcast communication indicative of location information associated with a PUE, a target Rx signal power associated with an antenna of the PUE, and a power margin to the target Rx signal power. For example, the wireless device 802 may receive, from a second wireless device (e.g., 804), a broadcast communication (e.g., 808) indicative of location information associated with a PUE (e.g., 806), a target Rx signal power associated with an antenna of the PUE, and a power margin to the target Rx signal power. In some aspects, 1002 may be performed by CW component 198.

At 1004, the wireless device may transmit, based on the location information, the target Rx signal power, or the power margin, a communication to the second wireless device to indicate a presence of the first wireless device to the PUE. For example, the wireless device 802 may transmit, based on the location information, the target Rx signal power, or the power margin, a communication (e.g., 814) to the second wireless device to indicate a presence of the first wireless device to the PUE (e.g., for RF source discovery). In some aspects, 1004 may be performed by CW component 198.

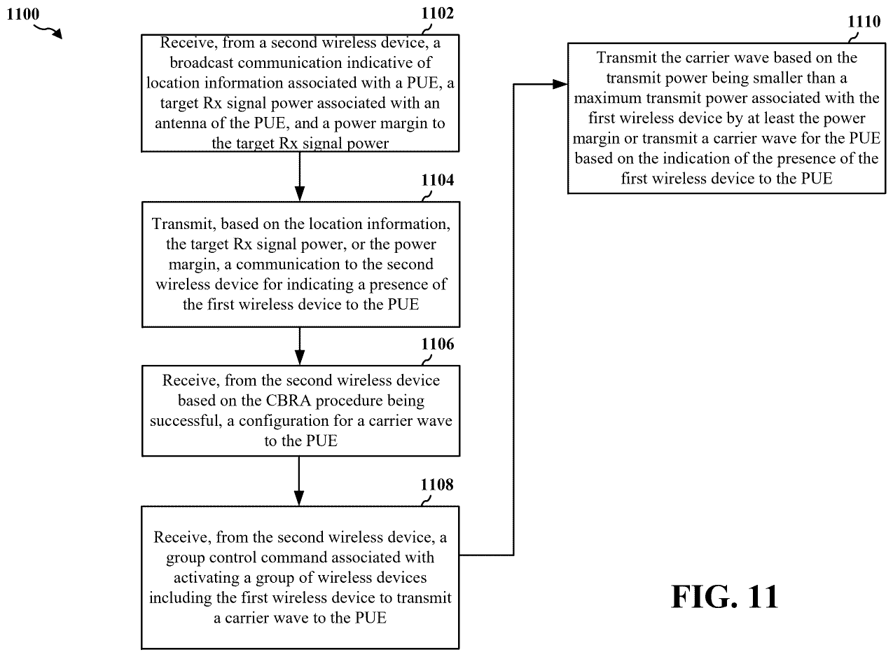

FIG. 11 is a flowchart 1100 of a method of wireless communication. The method may be performed by a first wireless device, such as a UE (e.g., the UE 104, the wireless device 802; the apparatus 1604). The method may be used to facilitate identifying RF sources for PUEs.

At 1102, the wireless device may receive, from a second wireless device, a broadcast communication indicative of location information associated with a PUE, a target Rx signal power associated with an antenna of the PUE, and a power margin to the target Rx signal power. For example, the wireless device 802 may receive, from a second wireless device (e.g., 804), a broadcast communication (e.g., 808) indicative of location information associated with a PUE (e.g., 806), a target Rx signal power associated with an antenna of the PUE, and a power margin to the target Rx signal power. In some aspects, 1102 may be performed by CW component 198. In some aspects, the location information associated with the PUE includes a location associated with the PUE or zone location information associated with the PUE.

At 1104, the wireless device may transmit, based on the location information, the target Rx signal power, or the power margin, a communication to the second wireless device to indicate a presence of the first wireless device to the PUE. For example, the wireless device 802 may transmit, based on the location information, the target Rx signal power, or the power margin, a communication (e.g., 814) to the second wireless device to indicate a presence of the first wireless device to the PUE (e.g., for RF source discovery). In some aspects, 1104 may be performed by CW component 198. In some aspects, the location information associated with the PUE includes zone location information associated with the PUE. In some of such aspects, the wireless device may transmit the communication based on the first wireless device and the PUE shares a same zone based on the zone location information. In some aspects, the location information associated with the PUE includes zone location information associated with the PUE. In some of such aspects, the wireless device may transmit the communication based on the first wireless device is associated with a first zone and the PUE is associated with a second zone indicated by the zone location information, where the first zone and the second zone are associated. In some aspects, to transmit the communication, the wireless device may perform a CBRA or CFRA procedure with the second wireless device to indicate a presence of the first wireless device. In some aspects, the wireless device may perform the CBRA procedure based on a set of RACH resources, where the set of RACH resources is based on the location information. In some aspects, the set of RACH resources correspond to a set of resources for backscattering by the PUE.

At 1106, the wireless device may receive, from the second wireless device based on the CBRA procedure being successful, a configuration for a carrier wave to the PUE, and where the configuration includes at least one of: a group random network temporary identifier (G-RNTI) for PDCCH monitoring, a list of available frequency resources associated with the carrier wave, or an index within a group associated with the PUE. For example, the wireless device 802 may receive, from the second wireless device (e.g., 804) based on the CBRA procedure or the CFRA procedure being successful, a configuration (e.g. 820) for a carrier wave to the PUE, and where the configuration includes at least one of: a group random network temporary identifier (G-RNTI) for PDCCH monitoring, a list of available frequency resources associated with the carrier wave, or an index within a group associated with the PUE. In some aspects, 1106 may be performed by CW component 198.

In some aspects, the wireless device may perform the CFRA procedure based on a reception of a PDCCH order from the second wireless device, where the PDCCH order includes the location information. In some aspects, each frequency in a set of frequencies available for a carrier wave to the PUE is equally spaced or separately configured.

At 1108, the wireless device may receive, from the second wireless device, a group control command associated with activating a group of wireless devices including the first wireless device to transmit a carrier wave to the PUE. For example, the wireless device 802 may receive, from the second wireless device (e.g., 804), a group control command (e.g., 824) associated with activating a group of wireless devices including the first wireless device to transmit a carrier wave to the PUE. In some aspects, 1108 may be performed by CW component 198. In some aspects, the group of wireless devices is a complete list of wireless devices for transmitting the carrier wave to the PUE, where each wireless device in the group of wireless devices is associated with a respective frequency in a set of frequencies available for the carrier wave. In some aspects, the group of wireless devices is a subset of wireless devices for transmitting the carrier wave to the PUE, where the subset is dynamically changed across one or more slots associated with the carrier wave to the PUE. In some aspects, the group control command includes a power control command for increasing or decreasing a transmit power associated with the carrier wave. In some aspects, the power control command is associated with all wireless devices in the group of wireless devices. In some aspects, the power control command includes multiple power control parameters, each of the multiple power control parameters being respectively associated with one wireless device in the group of wireless devices. In some aspects, each wireless device in the group of wireless devices is associated with a respective frequency in a set of frequencies available for the carrier wave, and where the group control command includes an indication associated with enabling or disabling the carrier wave on one or more frequencies in the set of frequencies.

In some aspects, the wireless device may estimate a minimum pathloss to the PUE based on the location information and a free space propagation model. In some aspects, the wireless device may determine a transmit power to transmit the communication based on the minimum pathloss and the target Rx signal power. At 1110, the wireless device may transmit the communication based on the transmit power being smaller than a maximum transmit power associated with the first wireless device by at least the power margin or transmit a carrier wave for the PUE based on the indication of the presence of the first wireless device to the PUE. For example, the wireless device 802 may transmit the communication (e.g., 814) based on the transmit power being smaller than a maximum transmit power associated with the first wireless device by at least the power margin or transmit a carrier wave (e.g., 826) for the PUE based on the indication of the presence of the first wireless device to the PUE. In some aspects, 1110 may be performed by CW component 198. As one example, if the maximum transmit power associated with (e.g., supported by) the first wireless device is equal to 23 dBm and the margin is equal to 6 dB, then if the transmit power is less than 23+6=29 dBm, then the wireless device may be assumed to be qualified for transmission. Otherwise the wireless device may determine (e.g., assumed to be) that it is too far away from the PUE and not required to transmit.

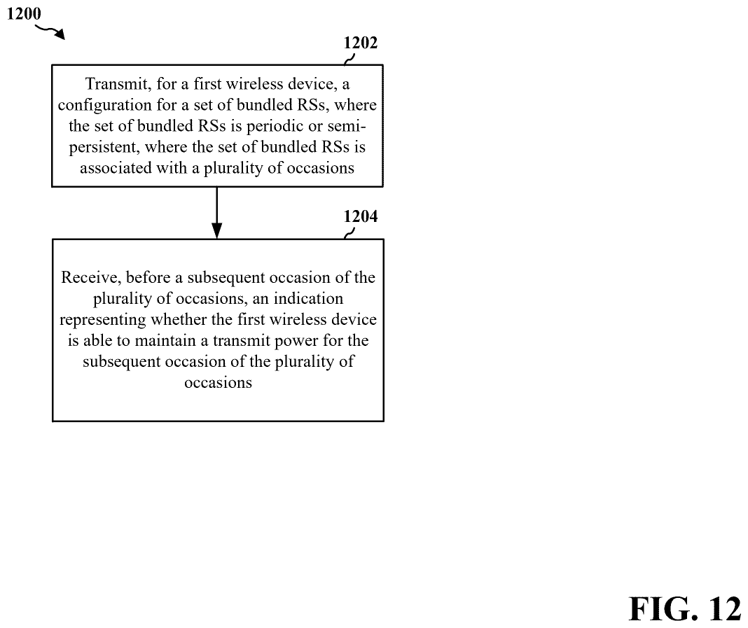

FIG. 12 is a flowchart 1200 of a method of wireless communication. The method may be performed by a first wireless device, such as a UE (e.g., the UE 104, the wireless device 802; the apparatus 1604). The method may be used to facilitate identifying RF sources for PUEs.

At 1202, the wireless device may receive, from a second wireless device, a group control command associated with activating a group of wireless devices including the first wireless device to transmit a carrier wave for a PUE. For example, the wireless device 802 may receive, from a second wireless device (e.g., 804), a group control command (e.g., 824) associated with activating a group of wireless devices including the first wireless device to transmit a carrier wave for a PUE (e.g., 806). In some aspects, 1102 may be performed by CW component 198.

At 1204, the wireless device may transmit, based on the group control command, the carrier wave to the PUE. For example, the wireless device 802 may transmit, based on the group control command (e.g., 824), the carrier wave (e.g., 826) to the PUE. In some aspects, 1104 may be performed by CW component 198.

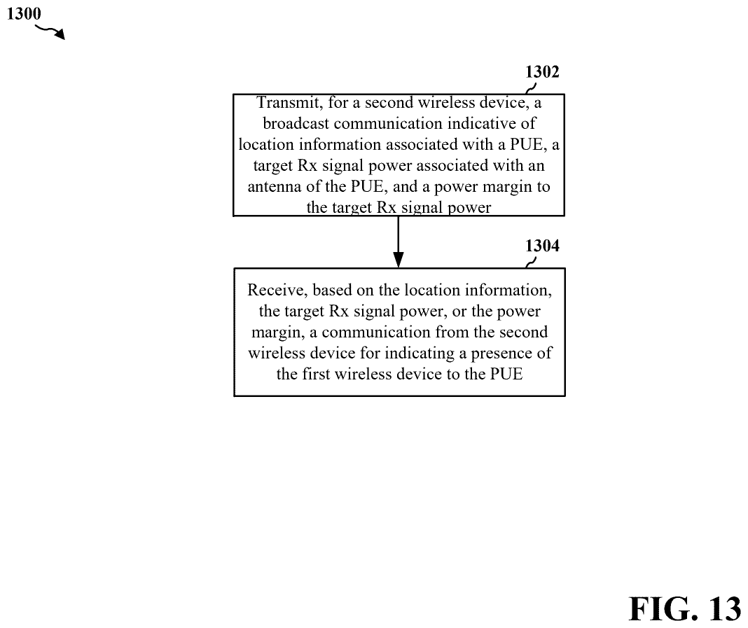

FIG. 13 is a flowchart 1300 of a method of wireless communication. The method may be performed by a wireless device, such as a UE or a network entity (e.g., the base station 102, the UE 104, the wireless device 804, the apparatus 1604, the network entity 1602, the network entity 1702). The method may be used to facilitate identifying RF sources for PUEs.

At 1302, the wireless device may transmit, to a second wireless device, a broadcast communication indicative of location information associated with a PUE, a target Rx signal power associated with an antenna of the PUE, and a power margin to the target Rx signal power. For example, the wireless device 804 may transmit, to a second wireless device (e.g., 802), a broadcast communication (e.g., 808) indicative of location information associated with a PUE (e.g., 806), a target Rx signal power associated with an antenna of the PUE, and a power margin to the target Rx signal power. In some aspects, 1302 may be performed by CW component 199. In some aspects, the location information associated with the PUE includes a location associated with the PUE or zone location information associated with the PUE.

At 1304, the wireless device may receive, based on the location information, the target Rx signal power, or the power margin, a communication from the second wireless device to indicate a presence of the first wireless device to the PUE. For example, the wireless device 804 may receive, based on the location information, the target Rx signal power, or the power margin, a communication (e.g., 814) from the second wireless device (e.g., 802) to indicate a presence of the first wireless device to the PUE (e.g., for RF source discovery). In some aspects, 1304 may be performed by CW component 199.

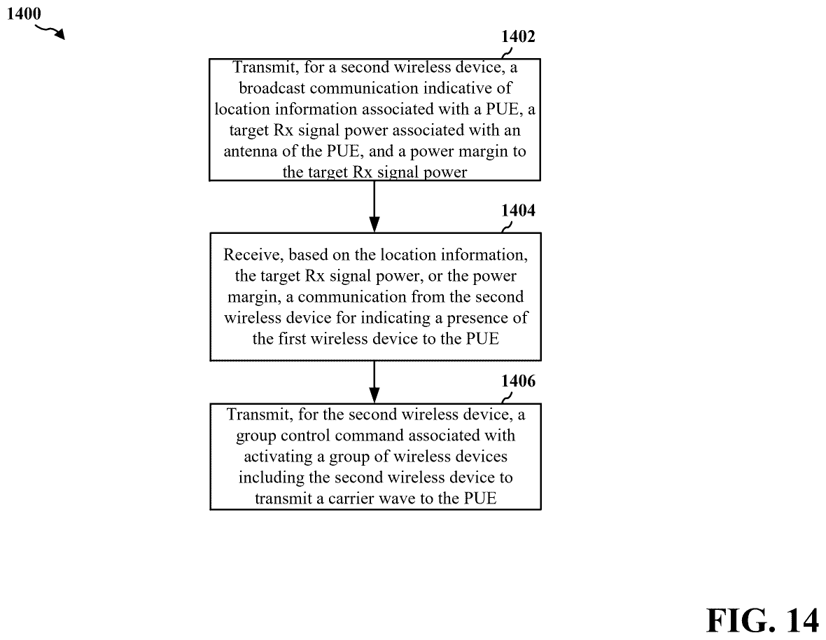

FIG. 14 is a flowchart 1400 of a method of wireless communication. The method may be performed by a wireless device, such as a UE or a network entity (e.g., the base station 102, the UE 104, the wireless device 804, the apparatus 1604, the network entity 1602, the network entity 1702). The method may be used to facilitate identifying RF sources for PUEs.

At 1402, the wireless device may transmit, to a second wireless device, a broadcast communication indicative of location information associated with a PUE, a target Rx signal power associated with an antenna of the PUE, and a power margin to the target Rx signal power. For example, the wireless device 804 may transmit, to a second wireless device (e.g., 802), a broadcast communication (e.g., 808) indicative of location information associated with a PUE (e.g., 806), a target Rx signal power associated with an antenna of the PUE, and a power margin to the target Rx signal power. In some aspects, 1402 may be performed by CW component 199. In some aspects, the location information associated with the PUE includes a location associated with the PUE or zone location information associated with the PUE.

At 1404, the wireless device may receive, based on the location information, the target Rx signal power, or the power margin, a communication from the second wireless device to indicate a presence of the first wireless device to the PUE. For example, the wireless device 804 may receive, based on the location information, the target Rx signal power, or the power margin, a communication (e.g., 814) from the second wireless device (e.g., 802) to indicate a presence of the first wireless device to the PUE (e.g., for RF source discovery). In some aspects, 1404 may be performed by CW component 199.

At 1406, the wireless device may transmit, for the second wireless device, a group control command associated with activating a group of wireless devices including the second wireless device to transmit a carrier wave to the PUE. For example, the wireless device 804 may transmit, for the second wireless device (e.g., 802), a group control command (e.g., 824) associated with activating a group of wireless devices including the second wireless device to transmit a carrier wave to the PUE. In some aspects, 1406 may be performed by CW component 199. In some aspects, the group of wireless devices is a complete list of wireless devices for transmitting the carrier wave to the PUE, where each wireless device in the group of wireless devices is associated with a respective frequency in a set of frequencies available for the carrier wave. In some aspects, the group of wireless devices is a subset of wireless devices for transmitting the carrier wave to the PUE, where the subset is dynamically changed across one or more slots associated with the carrier wave to the PUE. In some aspects, the group control command includes a power control command for increasing or decreasing a transmit power associated with the carrier wave. In some aspects, the power control command is associated with all wireless devices in the group of wireless devices. In some aspects, the power control command includes multiple power control parameters, each of the multiple power control parameters being respectively associated with one wireless device in the group of wireless devices. In some aspects, each wireless device in the group of wireless devices is associated with a respective frequency in a set of frequencies available for the carrier wave, and where the group control command includes an indication associated with enabling or disabling the carrier wave on one or more frequencies in the set of frequencies.

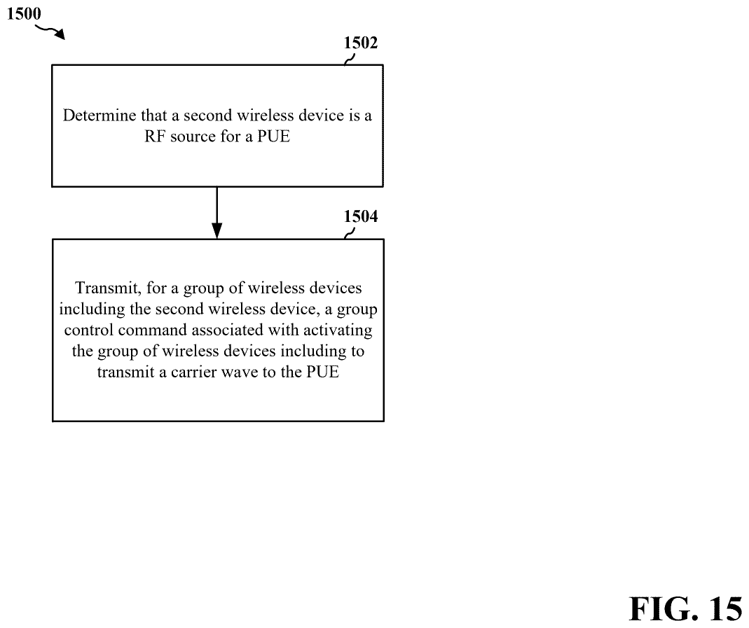

FIG. 15 is a flowchart 1500 of a method of wireless communication. The method may be performed by a wireless device, such as a UE or a network entity (e.g., the base station 102, the UE 104, the wireless device 804, the apparatus 1604, the network entity 1602, the network entity 1702). The method may be used to facilitate identifying RF sources for PUEs.

At 1502, the wireless device may determine that a second wireless device is a RF source for a PUE. For example, the wireless device 804 may determine that a second wireless device (e.g., 802) is a RF source for a PUE (e.g., 806). In some aspects, 1502 may be performed by CW component 199.

At 1504, the wireless device may transmit, for a group of wireless devices including the second wireless device, a group control command associated with activating the group of wireless devices including to transmit a carrier wave to the PUE. For example, the wireless device 804 may transmit, for a group of wireless devices including the second wireless device (e.g., 802), a group control command (e.g., 824) associated with activating the group of wireless devices including to transmit a carrier wave to the PUE. In some aspects, 1504 may be performed by CW component 199.

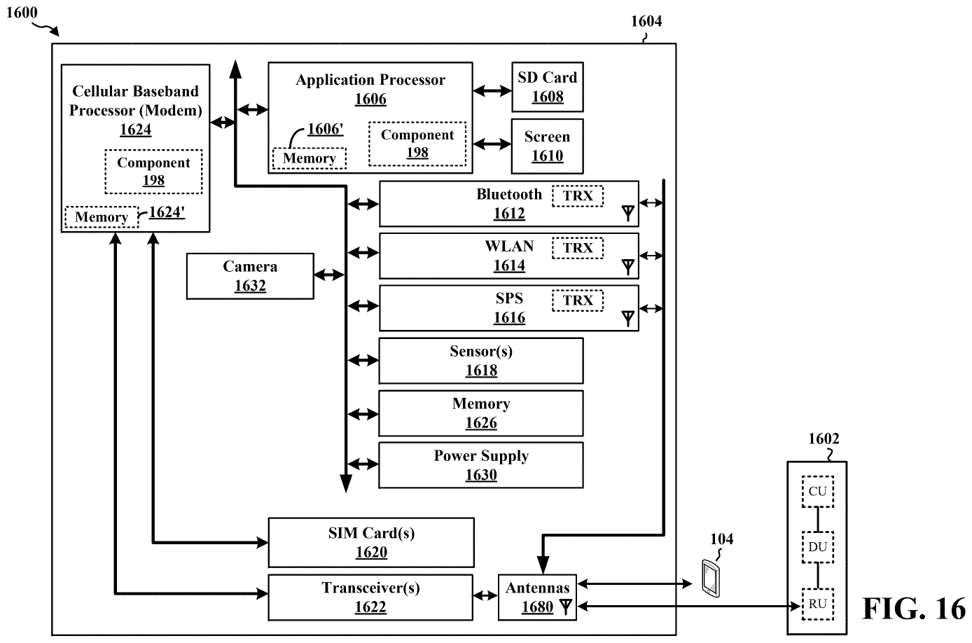

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IM), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the CW component 198 may be configured to receive, from a second wireless device, a broadcast communication indicative of location information associated with a PUE, a target Rx signal power associated with an antenna of the PUE, and a power margin to the target Rx signal power. In some aspects, the CW component 198 may be further configured to transmit, based on the location information, the target Rx signal power, or the power margin, a communication to the second wireless device to indicate a presence of the first wireless device to the PUE (e.g., for RF source discovery). In some aspects, the CW component 198 may be further configured to receive, from a second wireless device, a group control command associated with activating a group of wireless devices including the first wireless device to transmit a carrier wave for a PUE. In some aspects, the CW component 198 may be further configured to transmit, based on the group control command, the carrier wave to the PUE. The CW component 198 may be within the cellular baseband processor(s) 1624, the application processor(s) 1606, or both the cellular baseband processor(s) 1624 and the application processor(s) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for receiving, from a second wireless device, a broadcast communication indicative of location information associated with a PUE, a target Rx signal power associated with an antenna of the PUE, and a power margin to the target Rx signal power. In some aspects, the apparatus 1604 may include means for transmitting, based on the location information, the target Rx signal power, or the power margin, a communication to the second wireless device to indicate a presence of the first wireless device to the PUE. In some aspects, the apparatus 1604 may include means for estimating a minimum pathloss to the PUE based on the location information and a free space propagation model. In some aspects, the apparatus 1604 may include means for determining a transmit power to transmit the communication based on the minimum pathloss and the target Rx signal power. In some aspects, the apparatus 1604 may include means for transmitting the communication based on the transmit power being smaller than a maximum transmit power associated with the first wireless device by at least the power margin. In some aspects, the apparatus 1604 may include means for transmitting the communication based on the first wireless device and the PUE shares a same zone based on the zone location information. In some aspects, the apparatus 1604 may include means for transmitting the communication based on the first wireless device is associated with a first zone and the PUE is associated with a second zone indicated by the zone location information, where the first zone and the second zone are associated. In some aspects, the apparatus 1604 may include means for performing a contention based random access (CBRA) procedure or a contention free random access (CFRA) procedure with the second wireless device to indicate a presence of the first wireless device. In some aspects, the apparatus 1604 may include means for performing the CBRA procedure based on a set of RACH resources, where the set of RACH resources is based on the location information. In some aspects, the apparatus 1604 may include means for receiving, from the second wireless device based on the CBRA procedure being successful, a configuration for a carrier wave to the PUE, and where the configuration includes at least one of: a group random network temporary identifier (G-RNTI) for PDCCH monitoring, a list of available frequency resources associated with the carrier wave, or an index within a group associated with the PUE. In some aspects, the apparatus 1604 may include means for performing the CFRA procedure based on a reception of a PDCCH order from the second wireless device, where the PDCCH order includes the location information. In some aspects, the apparatus 1604 may include means for receiving, from the second wireless device, a group control command associated with activating a group of wireless devices including the first wireless device to transmit a carrier wave to the PUE. In some aspects, the apparatus 1604 may include means for transmitting a carrier wave for the PUE based on the RF source discovery. In some aspects, the apparatus 1604 may include means for receiving, from a second wireless device, a group control command associated with activating a group of wireless devices including the first wireless device to transmit a carrier wave for a PUE. In some aspects, the apparatus 1604 may include means for transmitting, based on the group control command, the carrier wave to the PUE. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

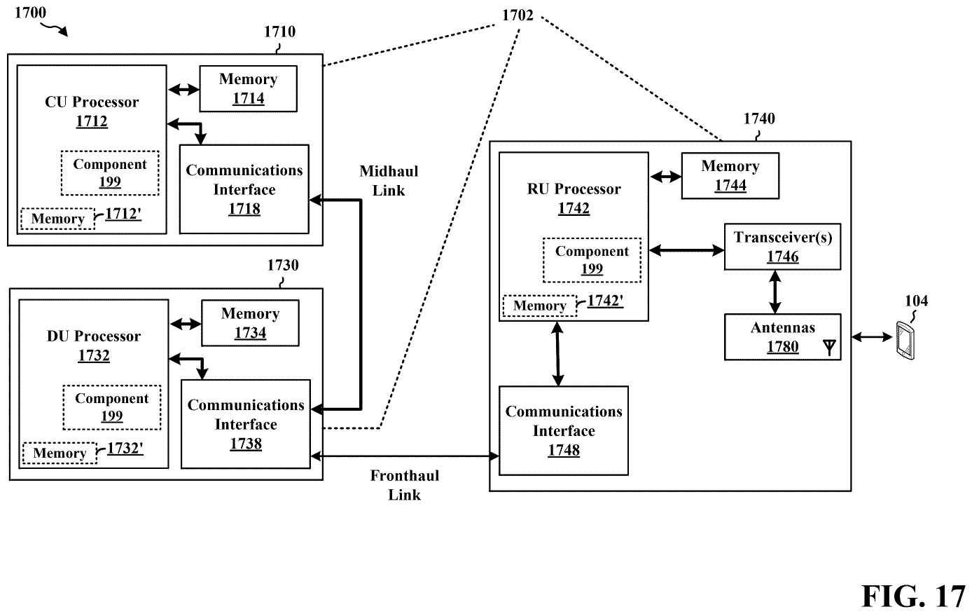

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CW component 199 may be configured to transmit, to a second wireless device, a broadcast communication indicative of location information associated with a PUE, a target Rx signal power associated with an antenna of the PUE, and a power margin to the target Rx signal power. In some aspects, the CW component 199 may be further configured to receive, based on the location information, the target Rx signal power, or the power margin, a communication from the second wireless device to indicate a presence of the first wireless device to the PUE. In some aspects, the CW component 199 may be further configured to determine that a second wireless device is a RF source for a PUE. In some aspects, the CW component 199 may be further configured to transmit, for a group of wireless devices including the second wireless device, a group control command associated with activating the group of wireless devices including to transmit a carrier wave to the PUE. The CW component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In some aspects, the network entity 1702 may include means for transmitting, to a second wireless device, a broadcast communication indicative of location information associated with a PUE, a target Rx signal power associated with an antenna of the PUE, and a power margin to the target Rx signal power. In some aspects, the network entity 1702 may include means for receiving, based on the location information, the target Rx signal power, or the power margin, a communication from the second wireless device to indicate a presence of the first wireless device to the PUE. In some aspects, the network entity 1702 may include means for transmitting, for the second wireless device, a group control command associated with activating a group of wireless devices including the second wireless device to transmit a carrier wave to the PUE. In some aspects, the network entity 1702 may include means for determining that a second wireless device is a RF source for a PUE. In some aspects, the network entity 1702 may include means for transmitting, for a group of wireless devices including the second wireless device, a group control command associated with activating the group of wireless devices including to transmit a carrier wave to the PUE. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a first wireless device, including: receiving, from a second wireless device, a broadcast communication indicative of location information associated with a passive user equipment (PUE), a target reception (Rx) signal power associated with an antenna of the PUE, and a power margin to the target Rx signal power; and transmitting, based on the location information, the target Rx signal power, or the power margin, a communication to the second wireless device to indicate a presence of the first wireless device to the PUE.

Aspect 2 is the method of aspect 1, where the location information associated with the PUE includes a location associated with the PUE or a zone location information associated with the PUE.

Aspect 3 is the method of any of aspects 1-2, further including: estimating a minimum pathloss to the PUE based on the location information and a free space propagation model; determining a transmit power to transmit the communication based on the minimum pathloss and the target Rx signal power; and transmitting the communication based on the transmit power being smaller than a maximum transmit power associated with the first wireless device by at least the power margin.

Aspect 4 is the method of any of aspects 1-3, where the location information associated with the PUE includes zone location information associated with the PUE, and further including: transmitting the communication based on the first wireless device and the PUE shares a same zone based on the zone location information.

Aspect 5 is the method of any of aspects 1-4, where the location information associated with the PUE includes zone location information associated with the PUE, and further including: transmitting the communication based on the first wireless device is associated with a first zone and the PUE is associated with a second zone indicated by the zone location information, where the first zone and the second zone are associated.

Aspect 6 is the method of any of aspects 1-5, where transmitting the communication further includes: performing a contention based random access (CBRA) procedure or a contention free random access (CFRA) procedure with the second wireless device to indicate the presence of the first wireless device to the PUE.

Aspect 7 is the method of aspect 6, further including: performing the CBRA procedure based on a set of random access channel (RACH) resources, where the set of RACH resources is based on the location information associated with the PUE.

Aspect 8 is the method of aspect 7, where the set of RACH resources correspond to a set of resources for backscattering by the PUE.

Aspect 9 is the method of any of aspects 7-8, further including: receiving, from the second wireless device based on the CBRA procedure being successful, a configuration for a carrier wave to the PUE, and where the configuration includes at least one of: a group random network temporary identifier (G-RNTI) for physical downlink control channel (PDCCH) monitoring, a list of available frequency resources associated with the carrier wave, or an index within a group associated with the PUE.

Aspect 10 is the method of aspect 6, further including: performing the CFRA procedure based on a reception of a physical downlink control channel (PDCCH) order from the second wireless device, where the PDCCH order includes the location information.

Aspect 11 is the method of any of aspects 1-10, where each frequency in a set of frequencies available for a carrier wave to the PUE is equally spaced or separately configured.

Aspect 12 is the method of any of aspects 1-11, further including: receiving, from the second wireless device, a group control command associated with activating a group of wireless devices including the first wireless device to transmit a carrier wave to the PUE.

Aspect 13 is the method of aspect 12, where the group of wireless devices is a complete list of wireless devices for transmitting the carrier wave to the PUE, where each wireless device in the group of wireless devices is associated with a respective frequency in a set of frequencies available for the carrier wave.

Aspect 14 is the method of aspect 12, where the group of wireless devices is a subset of wireless devices for transmitting the carrier wave to the PUE, where the subset of wireless devices is dynamically changed across one or more slots associated with the carrier wave to the PUE.

Aspect 15 is the method of any of aspects 12-14, where the group control command includes a power control command for increasing or decreasing a transmit power associated with the carrier wave.

Aspect 16 is the method of aspect 15, where the power control command is associated with all wireless devices in the group of wireless devices.

Aspect 17 is the method of aspect 15, where the power control command includes multiple power control parameters, each of the multiple power control parameters being respectively associated with one wireless device in the group of wireless devices.

Aspect 18 is the method of any of aspects 12-17, where each wireless device in the group of wireless devices is associated with a respective frequency in a set of frequencies available for the carrier wave, and where the group control command includes an indication associated with enabling or disabling the carrier wave on one or more frequencies in the set of frequencies.

Aspect 19 is the method of any of aspects 1-18, further including: transmitting a carrier wave for the PUE based on the indication of the presence of the first wireless device to the PUE.

Aspect 20 is a method for wireless communication performed by a first wireless device, including: receiving, from a second wireless device, a group control command associated with activating a group of wireless devices including the first wireless device to transmit a carrier wave for a passive user equipment (PUE); and transmitting, based on the group control command, the carrier wave to the PUE.

Aspect 21 is a method for wireless communication performed by a first wireless device, including: transmitting, to a second wireless device, a broadcast communication indicative of location information associated with a passive user equipment (PUE), a target reception (Rx) signal power associated with an antenna of the PUE, and a power margin to the target Rx signal power; and receiving, based on the location information, the target Rx signal power, or the power margin, a communication from the second wireless device for indicating a presence of the first wireless device to the PUE.

Aspect 22 is the method of aspect 21, where the location information associated with the PUE includes a location associated with the PUE or a zone location information associated with the PUE.

Aspect 23 is the method of any of aspects 21-22, further including: transmitting, for the second wireless device, a group control command associated with activating a group of wireless devices including the second wireless device to transmit a carrier wave to the PUE.

Aspect 24 is the method of aspect 23, where the group of wireless devices is a complete list of wireless devices for transmitting the carrier wave to the PUE, where each wireless device in the group of wireless devices is associated with a respective frequency in a set of frequencies available for the carrier wave.

Aspect 25 is the method of aspect 23, where the group of wireless devices is a subset of wireless devices for transmitting the carrier wave to the PUE, where the subset of wireless devices is dynamically changed across one or more slots associated with the carrier wave to the PUE.

Aspect 26 is the method of any of aspects 23-25, where the group control command includes a power control command for increasing or decreasing a transmit power associated with the carrier wave.

Aspect 27 is the method of aspect 26, where the power control command is associated with all wireless devices in the group of wireless devices.

Aspect 28 is the method of aspect 26, where the power control command includes multiple power control parameters, each of the multiple power control parameters being respectively associated with one wireless device in the group of wireless devices.

Aspect 29 is the method of any of aspects 23-28, where each wireless device in the group of wireless devices is associated with a respective frequency in a set of frequencies available for the carrier wave, and where the group control command includes an indication associated with enabling or disabling the carrier wave on one or more frequencies in the set of frequencies.

Aspect 30 is a method for wireless communication performed by a first wireless device, including: determining that a second wireless device is a radio frequency (RF) source for a passive user equipment (PUE); and transmitting, for a group of wireless devices including the second wireless device, a group control command associated with activating the group of wireless devices including to transmit a carrier wave to the PUE.

Aspect 31 is an apparatus for wireless communication at a device (e.g., a network node) including at least one memory and at least one processor coupled to the at least one memory and, based at least in part on information stored in the at least one memory, the at least one processor is configured, individually or in combination, to implement any of aspects 1 to 20.

Aspect 32 is the apparatus of aspect 31, further including one or more transceivers or one or more antennas coupled to the at least one processor.

Aspect 33 is an apparatus for wireless communication at a device including means for implementing any of aspects 1 to 20.

Aspect 34 is a computer-readable medium (e.g., a non-transitory computer-readable medium) storing computer executable code, where the code when executed by at least one processor causes the at least one processor to implement any of aspects 1 to 20.

Aspect 35 is an apparatus for wireless communication at a device (e.g., a network node) including at least one memory and at least one processor coupled to the at least one memory and, based at least in part on information stored in the at least one memory, the at least one processor is configured, individually or in combination, to implement any of aspects 21 to 30.

Aspect 36 is the apparatus of aspect 35, further including one or more transceivers or one or more antennas coupled to the at least one processor.

Aspect 37 is an apparatus for wireless communication at a device including means for implementing any of aspects 21 to 30.

Aspect 38 is a computer-readable medium (e.g., a non-transitory computer-readable medium) storing computer executable code, where the code when executed by at least one processor causes the at least one processor to implement any of aspects 21 to 30.

1. An apparatus for wireless communication at a first wireless device, comprising:
at least one memory; and
at least one processor coupled to the at least one memory and, based at least in part on information stored in the at least one memory, the at least one processor, individually or in any combination, is configured to:
receive, from a second wireless device, a broadcast communication indicative of location information associated with a passive user equipment (PUE), a target reception (Rx) signal power associated with an antenna of the PUE, and a power margin to the target Rx signal power; and
transmit, based on the location information, the target Rx signal power, or the power margin, a communication to the second wireless device to indicate a presence of the first wireless device to the PUE.

2. The apparatus of claim 1, wherein the location information associated with the PUE comprises a location associated with the PUE or a zone location information associated with the PUE.

3. The apparatus of claim 1, wherein the at least one processor is configured to:
estimate a minimum pathloss to the PUE based on the location information and a free space propagation model;
determine a transmit power to transmit the communication based on the minimum pathloss and the target Rx signal power; and
transmit the communication based on the transmit power being smaller than a maximum transmit power associated with the first wireless device by at least the power margin.

4. The apparatus of claim 1, wherein the location information associated with the PUE comprises zone location information associated with the PUE, wherein the at least one processor is configured to:
transmit the communication based on the first wireless device and the PUE shares a same zone based on the zone location information.

5. The apparatus of claim 1, wherein the location information associated with the PUE comprises zone location information associated with the PUE, wherein the at least one processor is configured to:
transmit the communication based on the first wireless device is associated with a first zone and the PUE is associated with a second zone indicated by the zone location information, wherein the first zone and the second zone are associated.

6. The apparatus of claim 1, wherein to transmit the communication, the at least one processor is configured to:
perform a contention based random access (CBRA) procedure or a contention free random access (CFRA) procedure with the second wireless device to indicate the presence of the first wireless device to the PUE.

7. The apparatus of claim 6, wherein the at least one processor is configured to:
perform the CBRA procedure based on a set of random access channel (RACH) resources, wherein the set of RACH resources is based on the location information associated with the PUE.

8. The apparatus of claim 7, wherein the set of RACH resources correspond to a set of resources for backscattering by the PUE.

9. The apparatus of claim 7, wherein the at least one processor is configured to:
receive, from the second wireless device based on the CBRA procedure being successful, a configuration for a carrier wave to the PUE, and wherein the configuration includes at least one of: a group random network temporary identifier (G-RNTI) for physical downlink control channel (PDCCH) monitoring, a list of available frequency resources associated with the carrier wave, or an index within a group associated with the PUE.

10. The apparatus of claim 6, wherein the at least one processor is configured to:
perform the CFRA procedure based on a reception of a physical downlink control channel (PDCCH) order from the second wireless device, wherein the PDCCH order comprises the location information.

11. The apparatus of claim 1, wherein each frequency in a set of frequencies available for a carrier wave to the PUE is equally spaced or separately configured.

12. The apparatus of claim 1, wherein the at least one processor is configured to:
receive, from the second wireless device, a group control command associated with activating a group of wireless devices including the first wireless device to transmit a carrier wave to the PUE.

13. The apparatus of claim 12, wherein the group of wireless devices is a complete list of wireless devices for transmitting the carrier wave to the PUE, wherein each wireless device in the group of wireless devices is associated with a respective frequency in a set of frequencies available for the carrier wave.

14. The apparatus of claim 12, wherein the group of wireless devices is a subset of wireless devices for transmitting the carrier wave to the PUE, wherein the subset of wireless devices is dynamically changed across one or more slots associated with the carrier wave to the PUE.

15. The apparatus of claim 12, wherein the group control command comprises a power control command for increasing or decreasing a transmit power associated with the carrier wave.

16. The apparatus of claim 15, wherein the power control command is associated with all wireless devices in the group of wireless devices.

17. (canceled)

18. The apparatus of claim 12, wherein each wireless device in the group of wireless devices is associated with a respective frequency in a set of frequencies available for the carrier wave, and wherein the group control command includes an indication associated with enabling or disabling the carrier wave on one or more frequencies in the set of frequencies.

19. The apparatus of claim 1, wherein the at least one processor is configured to:
transmit a carrier wave for the PUE based on the indication of the presence of the first wireless device to the PUE.

20. An apparatus for wireless communication at a first wireless device, comprising:
at least one memory; and
at least one processor coupled to the at least one memory and, based at least in part on information stored in the at least one memory, the at least one processor, individually or in any combination, is configured to:
receive, from a second wireless device, a group control command associated with activating a group of wireless devices including the first wireless device to transmit a carrier wave for a passive user equipment (PUE); and
transmit, based on the group control command, the carrier wave to the PUE.

21. An apparatus for wireless communication at a first wireless device, comprising:
at least one memory; and
at least one processor coupled to the at least one memory and, based at least in part on information stored in the at least one memory, the at least one processor, individually or in any combination, is configured to:
transmit, to a second wireless device, a broadcast communication indicative of location information associated with a passive user equipment (PUE), a target reception (Rx) signal power associated with an antenna of the PUE, and a power margin to the target Rx signal power; and
receive, based on the location information, the target Rx signal power, or the power margin, a communication from the second wireless device for indicating a presence of the first wireless device to the PUE.

22-30. (canceled)
